(19) United States
(12) Patent Application Publication
(10) Pub. No.: US 2005/0187912 A1
(43) Pub. Date: Aug. 25, 2005

(54) Management of configuration data using extensible markup language

(75) Inventors: Moshe E. Matsa, Cambridge, MA (US); Julius Q. Quiaot, San Jose, CA (US); Christopher R. Vincent, Arlington, MA (US); Thomas D. Brown, Champaign, IL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 10/786,786

(22) Filed: Feb. 24, 2004

(51) Int. Cl. G06F 7/00

(52) U.S. Cl. 707/3

(57) ABSTRACT

A system, method and computer program product are provided for managing configuration data. According to the method, a plurality of configuration values are stored in a hierarchical tree having a plurality of nodes, a defined structure, and defined data types for the stored configuration values, with each node being associated with at least one configuration value. At least one application component is registered with at least one of the nodes of the tree, based on at least one query received from the at least one application component. The at least one application component is notified when a configuration value associated with the at least one node is modified, based on an addition or change in at least one configuration value that matches the at least one query. In a preferred embodiment, the hierarchical tree is an Extensible Markup Language (XML) tree, and an XML schema describes the structure of the XML tree and the data types that are stored.

### BACKGROUND OF THE INVENTION

1. Field of the Invention

This invention generally relates to the field of data management and more specifically to dynamic configuration data management.

2. Description of Related Art

Application components, such as a Graphical User Interface (GUI), an object, an Application Programming Interface (API), a plug-in, an application, a user or the like, often need to handle configuration data that dictates how an application component will behave and interact with other application components. Configuration data includes a plurality of configuration values, such as data associated with any of: user login information, an email application, an instant messaging application, a word processing application, a spreadsheet application, an image processing application or the like. As configuration data changes, application components must be able to receive those changes to operate effectively. Thus, techniques for handling configuration data must be able to handle changing configuration data, as well as arbitrary sets of data.

An example of conventional configuration data handling will be explained with reference to an email application. Examples of configuration values that are required by the email application are the user's preferred server for receiving incoming email, the protocol with which to retrieve the mail, the user name, the reply-to address, and various other information. An interface, such as a GUI, may allow the user to change any of the configuration data by clicking on a menu option, such as ‘Properties’, altering data in the GUI and clicking ‘OK’. At this point, an update of the configuration data occurs.

In a conventional system that manages configuration data, upon clicking ‘OK’, for each configuration value that is changed, there is a corresponding code segment that is invoked. This code segment identifies those variables that must be altered and which application components must be informed. For example, for certain configuration values, the mail retrieval component must be notified, for certain configuration values the mail sending component must be notified, for some configuration values all active windows of the application must be notified, and so on. Finally, the modified configuration values must be written to some persistent storage. Thus, in a conventional system that manages configuration data, when functionality is added to the application, code segments must be added: 1) for the new functionality, and 2) to the code for the properties dialog box such that it informs the new function when configuration values are modified. As different modules of code are tied together, the entire code is rendered more complex and harder to write, change, and understand.

The Microsoft Windows operating system does include a “registry” that stores configuration data in a tree format. More specifically, the registry is a system-defined database in which each node in the tree is called a registry key. Each registry key can contain subkeys and/or data values. Applications and system components use the registry API to store and manipulate configuration data in the registry's tree. In Windows 98 and newer versions, the registry API includes a function, RegNotifyChangeKeyValue, that notifies the caller about changes to the attributes or contents of a specified registry key. (A complete description is available on the Web for the Windows registry at “msdn.microsoft.com/library/default.asp?url=/library/en-us/sysinfo/base/registry. asp” and the links therein, and for the RegNotifyChangeKeyValue function at “msdn.microsoft.com/library/default.asp?url=/library/en-us/sysinfo/base/regnotify changekeyvalue.asp”, which descriptions are herein incorporated by reference.) While Microsoft Windows does include the registry for storing configuration values, the RegNotifyChangeKeyValue function provides an application component with only limited functionality for registering for notification of changes in the stored configuration data.

Therefore a need exists to overcome the problems discussed above, and particularly for a way to more efficiently manage configuration data.

### SUMMARY OF THE INVENTION

Briefly, in accordance with the present invention, disclosed is a system, method and computer program product for managing configuration data. One embodiment of the present invention provides a method for managing configuration data. According to the method, a plurality of configuration values are stored in a hierarchical tree having a plurality of nodes, a defined structure, and defined data types for the stored configuration values, with each node being associated with at least one configuration value. At least one application component is registered with at least one of the nodes of the tree, based on at least one query received from the at least one application component. The at least one application component is notified when a configuration value associated with the at least one node is modified, based on an addition or change in at least one configuration value that matches the at least one query. In a preferred embodiment, the hierarchical tree is an Extensible Markup Language (XML) tree, and an XML schema describes the structure of the XML tree and the data types that are stored.

Another embodiment of the present invention provides a computer system for managing configuration data. The computer system includes an organization module that organizes a plurality of configuration values into a hierarchical tree having a plurality of nodes, a defined structure, and defined data types for the stored configuration values, with each node being associated with at least one configuration value. The computer system further includes storage that stores the plurality of configuration values in the hierarchical tree and a registration module that registers at least one application component with at least one of the nodes of the tree, based on at least one query received from the at least one application component. The computer system also includes a notification module that notifies the at least one application component when a configuration value associated with the at least one node is modified, based on an addition or change in at least one configuration value that matches the at least one query.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a block diagram illustrating the overall system architecture of one embodiment of the present invention.

FIG. 2 is a flowchart depicting the overall operation and control flow of the hierarchical configuration manager of one embodiment of the present invention.

FIG. 3 is a flowchart depicting the operation and control flow of the application component start-up process of one embodiment of the present invention.

FIG. 4 is a flowchart depicting the operation and control flow of the application component execution process of one embodiment of the present invention.

FIG. 5 is a block diagram of an exemplary system architecture for an instant messaging application according to one embodiment of the present invention.

FIG. 6 is a block diagram of a computer system useful for implementing the present invention.

### DETAILED DESCRIPTION OF PREFERRED EMBODIMENTS

### 1. Introduction

The present invention, according to a preferred embodiment, overcomes problems with the prior art by providing an efficient and easy-to-implement method for managing configuration data using Extensible Markup Language (XML).

Preferred embodiments of the present invention provide the ability for application components, such as a Graphical User Interface (GUI), an object, an Application Programming Interface (API), a plug-in, an application, a user or the like, to handle changing configuration data, and handle configuration data in a hierarchical structure (for example, using the extensibility of XML). Configuration data includes a plurality of configuration values.

The embodiments of the present invention organize configuration data into a hierarchical tree. Application components can register interest in a particular node of the tree, or a particular sub-tree. By registering interest, these components receive notifications whenever a configuration value changes. Any component that is a current holder of a registration or reference will be notified when a configuration value changes. Because the configuration values are arranged hierarchically in a tree such as an XML tree, the programmer and various application components can register for callbacks or notification upon modification of any nodes in any sub-tree.

The structure of the configuration data in the XML tree can be altered, for example by adding more sub-nodes to a particular node in the tree. An interested party to the changed sub-tree will now receive the new configuration data, but will only utilize what that party originally was programmed to handle. In other words, the addition of new data to a sub-tree has no effect on a registered party's ability to handle that sub-tree of configuration data.

The present invention allows an application component to register itself as an interested party to any change in a configuration value. The present invention preferably uses XML to organize the configuration data, and allows an application component to register itself as an interested party to not only a single configuration value but possibly an entire sub-tree of configuration values. Also, because XML is used to represent the tree, a sub-tree of configuration data can easily be expanded, with no change in how an application component handles those configuration values.

### 2. Using XML and Hierarchical Trees

As explained above, the present invention provides a method for managing configuration data using a hierarchical structure. The present invention provides the ability for application components, such as a GUI, an object, an API, a plug-in, an application, a user or the like, to handle changing configuration data, and preferably utilizes the extensibility of XML to handle the configuration data by organizing it into an XML tree.

XML is an initiative defining a simple dialect of Standard Generalized Markup Language (SGML) suitable for use on the World-Wide Web. XML is a simple, very flexible text format derived from SGML (ISO 8879). Originally designed for large-scale electronic publishing, XML is playing an increasingly important role in the exchange of a wide variety of data on the Web and elsewhere. The current XML specifications, “Extensible Markup Language (XML) 1.0 (Second Edition)” and “XML 1.1”, are available on the Internet at “www.w3.org/XML/Core/#Publications”, which is herein incorporated by reference.

Structured data includes items like spreadsheets, address books, configuration parameters, financial transactions, and technical drawings. XML is a set of rules for designing text formats for the structuring of data. XML is not a programming language. XML allows an application to generate data, read data, and ensure that a data structure is unambiguous. XML avoids common pitfalls in language design: it is extensible, platform-independent, and supports internationalization and localization. XML is fully Unicode-compliant.

SGML is a generic markup language for representing documents. SGML is an International Standard that describes the relationship between a document's content and its structure. SGML allows document-based information to be shared and re-used across applications and computer platforms in an open, vendor-neutral format. SGML is sometimes compared to Structured Query Language (SQL), in that it enables companies to structure information in documents in an open fashion, so that it can be accessed or re-used by any SGML-aware application across multiple platforms. SGML is defined in “ISO 8879:1986 Information processing—Text and office systems—Standard Generalized Markup Language (SGML)”, which is available from the International Organization for Standardization (www.iso.ch) and herein incorporated by reference.

Unlike other common document file formats that represent both content and presentation, SGML represents only a document's content data and structure (interrelationships among the data). Removing the presentation from content establishes a neutral format. SGML documents and the information in them can be re-used by publishing and non-publishing applications.

SGML identifies document elements such as titles, paragraphs, tables and chapters as distinct objects, allowing users to define the relationships between the objects for structuring data in documents. The relationships between document elements are defined in a DTD (Document Type Descriptor). This is roughly analogous to a collection of field definitions in a database. Once a document is converted into SGML and the information has been ‘tagged’ with DTDs, it becomes a database-like document. It can be searched, printed or even programmatically manipulated by SGML-aware applications.

As explained above, the present invention organizes configuration data into a hierarchical tree. A tree comprises a plurality of nodes and relationships between nodes. Various types of trees can be used. A binary tree is a tree in which each node has at most two successors or child nodes. A balanced tree is an optimization of a binary tree, which aims to keep equal numbers of items on each side of each node so as to minimize the maximum path from the root to any leaf node. As items are inserted and deleted with a binary tree, the tree is restructured to keep the nodes balanced and the search paths uniform. Such a tree is appropriate when the overhead for the reorganization of the tree on update is outweighed by the benefits of faster searching through a tree.

In one embodiment of the present invention, each node of the tree includes at least one configuration value, and, optionally, a reference to at least one other node. Configuration values can be any configuration data, such as data associated with user login information, an email application, an instant messaging application, a word processing application, a spreadsheet application, or an image processing application.

### 3. Exemplary Email Application Implementation Using XML

An email application is described below to illustrate the principles of one embodiment of the present invention. Examples of configuration values that are required by various components of the email application are the user's preferred server for receiving incoming email, the protocol with which to retrieve the mail, the user name, the reply-to address, and various other information. An interface, such as a GUI, may allow the user to change any of the configuration data above by clicking on a menu option, such as ‘Properties’, altering data in the GUI and clicking ‘OK’. At this point, an update of the configuration data occurs.

In a conventional system that manages configuration data, upon clicking ‘OK’, for each configuration value that is changed, there is a corresponding code segment that is invoked. This code segment identifies those variables that must be altered and which application components must be informed. For example, for certain configuration values, the mail retrieval component must be notified, for certain configuration values the mail sending component must be notified, for some configuration values all active windows of the application must be notified, and so on. Finally, the modified configuration values must be written to some persistent storage. Thus, in a conventional system that manages configuration data, when functionality is added to the application, code segments must be added 1) for the new functionality and, 2) to the code for the properties dialog box such that it informs the new function when configuration values are modified. As different modules of code are tied together, the entire code is rendered more complex and harder to write, change, and understand.

The present invention, however, provides advantages over a conventional system that manages configuration data. The present invention includes a Hierarchical Configuration Manager (HCM) that manages all configuration data. Upon start-up, the HCM of the preferred embodiment initializes from some persistent store, such as a configuration file of saved configuration values. When each application component starts-up or changes, it checks the configuration values in the HCM, and utilizes them. If the application component requires the current version of a configuration value, the application component registers for callback, or notification, with the HCM upon change of that configuration value.

For example, an email reply window might register for the configuration value ‘Properties/User Settings/User Data/Current User/Reply To Address’ which is originally set to ‘default@example.com’. This configuration value is then displayed in the email reply window as if it is part of the current email message. If the user then changes the reply-to address to ‘me@example.com’ the HCM is notified of the change. Application components that register with this configuration value are notified of the change by the HCM, which also writes the new data out to persistent storage.

Thus, using the present invention, when adding functionality to an application, only code segments describing the new functionality must be added. Because of the extensible and hierarchical nature of the tree used by the HCM, there is no need for new code segments to be added to the HCM. If one application component registers for all configuration values in a sub-tree, that application component will receive all of those configuration values even if some of the configuration values were added by code written after the requesting process was written. In this case, the application component can either ignore the new configuration values or display them in a generic fashion. This paradigm decouples the code that alters configuration data from the code that uses the configuration data. The result of this improved process is that code is simpler, less complex, and easier to write, change, and understand.

### 4. Exemplary Instant Messaging Application Implementation

An instant messaging application is described below to illustrate the principles of another embodiment of the present invention. The instant messaging application is written in a programming language, such as a high level object-oriented language (e.g., C++). The instant messaging application allows the instantaneous exchange of text messages between users, who are typically connected via a central server. The instant messaging application allows users to maintain lists of users (i.e., buddy lists), view the status of users (e.g., currently online, offline, busy and not accepting messages) and compose and send text messages.

Different application components manage various aspects of the instant messaging application. For example, the Graphical User Interface (GUI) application component handles graphical display of the buddy list, perhaps using colors and icons to indicate buddy status (online and offline), and provides a means for the user to send and receive messages to buddies. Underneath the interface is the application's “business logic”, for managing connections to various instant messaging servers, internal representations of buddy lists, information about the current user of the application, preferences, and so on.

Conventionally, each application component maintains its list of configuration values that it requires for operation. For instance, the GUI application component maintains its own buddy list, along with extra information possibly needed for display purposes (see List A below). A connection manager application component maintains its version of a buddy list, with information related to the type of connection each buddy uses (see List B below).

```
LIST A
    BUDDY: Abe; STATUS: Online; ICON: 1
    BUDDY: Bill; STATUS: Busy; ICON: 2
    BUDDY: Carol; STATUS: Offline; ICON: 3
LIST B
    BUDDY: Abe; SERVER: AOL
    BUDDY: Bill; SERVER: Sametime
    BUDDY: Carol; SERVER: Yahoo
```

In this embodiment of the present invention, all the configuration data that each application component requires is consolidated into one managing object. Furthermore, the configuration values are arranged in a way that allows application components to share common data in addition to data specific to each component. Additionally, application components are allowed to register interest in one or more configuration values, so that the application component can be notified if any changes occur.

The managing object is referred to as a Hierarchal Configuration Manager, or HCM. The HCM internally maintains a tree structure for the configuration data, with sub-trees representing collections of related data. Below is shown a subset of an XML tree data structure that holds configuration data, including the buddy list configuration data of List A and List B above.

```
<CONFIG>
    <BUDDYLIST>
        <BUDDY>
            <NAME>Abe</NAME>
            <STATUS>Online</STATUS>
            <ICON>1</ICON>
            <SERVER>AOL</SERVER>
        </BUDDY>
        <BUDDY>
            <NAME>Bill</NAME>
            <STATUS>Busy</STATUS>
            <ICON >2</ICON>
            <SERVER>Sametime</SERVER>
        </BUDDY>
        <BUDDY>
            <NAME>Carol</NAME>
            <STATUS>Offline</STATUS>
            <ICON>3</ICON>
            <SERVER>Yahoo</SERVER>
        </BUDDY>
    </BUDDYLIST>
</CONFIG>
```

The HCM maintains the configuration data for all application components. Where configuration data may overlap, the HCM nests them under a common sub-tree. In our example, both the user interface application component and the connection manager application component require knowledge of the buddy list. Both application components would query the HCM for the sub-tree CONFIG:BUDDYLIST, and would receive all the configuration data in that sub-tree. The user interface application component can then access configuration data for each BUDDY in the BUDDYLIST, and only use the configuration values it needs—namely, the buddy name, icon, and status configuration values. Similarly, the connection manager application component only uses the buddy name and server configuration values.

In addition to this consolidation and reorganization of configuration data, the HCM provides a facility for application components to register “interest” in subsets or sub-trees of configuration data. In one embodiment, the user interface application component needs to know if and when a buddy's status changes. Another application component, such as a status updater application component, communicates with the instant messaging servers and receives notifications for any status changes. When a status change occurs, the status updater application component sends a message to the HCM. The HCM determines which buddy's status has changed, and updates its internal data structures accordingly. Furthermore, because the user interface application component has registered its interest for changes in buddy status, the HCM will send the updated data (or a notification of data update) to the user interface application component, at which point the user interface application component can update its display.

The hierarchical nature of the HCM and the XML tree provides various advantages. One advantage is a uniform interface for managing and accessing configuration data. Another advantage is that the code that each individual application component must implement to manage its configuration data is consolidated into one managing object—the HCM. Application components send a message to or issue a function call against the HCM to retrieve a sub-tree or subset of configuration data. Standard APIs are used to navigate the sub-tree and retrieve specific configuration values. For example, in an XML implementation, generic XML tree manipulation APIs, such as the MSXML library, can be used.

### 5. Overview of the System

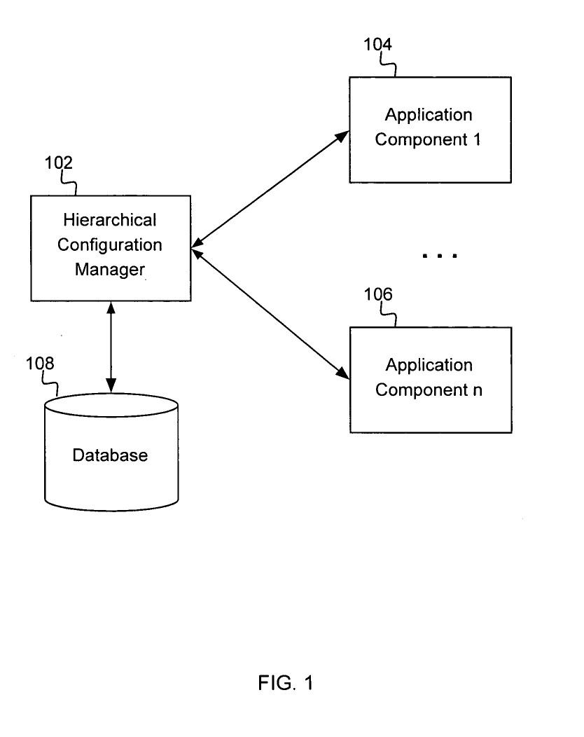

FIG. 1 is a block diagram illustrating the overall system architecture of one embodiment of the present invention. FIG. 1 shows the HCM 102, and a database 108, which is any commercially available data repository system or database, including a database management system.

FIG. 1 further shows application components 104 through 106, which comprise the components of an application program, such as an email application, an instant messaging application, a word processing application, a spreadsheet application or an image processing application. An application component can be a GUI, an object, an API, a plug-in, an application, a user or the like. Although FIG. 1 shows only two application components 104 and 106, the present invention supports any number of application components and subcomponents.

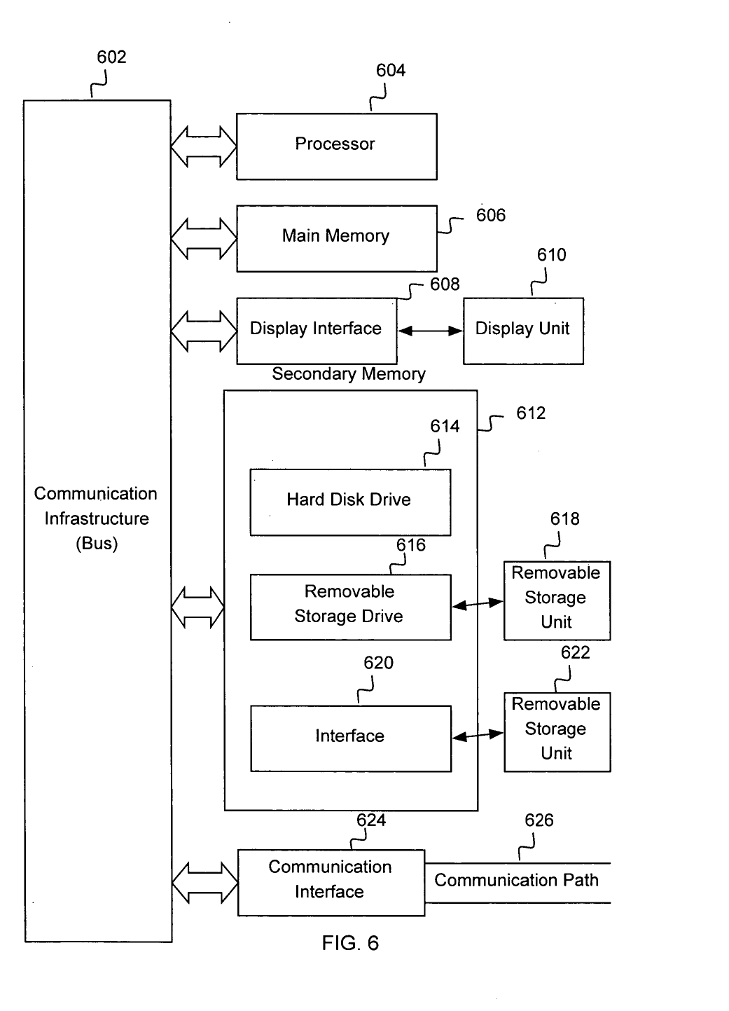

In this embodiment of the present invention, the system of FIG. 1 is one or more Personal Computers (PCs) (e.g., IBM or compatible PC workstations running the Microsoft Windows operating system, Macintosh computers running the Mac OS operating system, or equivalent), mainframe computers (e.g., IBM S/390), Personal Digital Assistants (PDAs), hand held computers, palm top computers, smart phones, game consoles or any other information processing devices. In another embodiment, the system of FIG. 1 is a server system (e.g., SUN Ultra workstations running the SunOS operating system or IBM RS/6000 workstations and servers running the AIX operating system). The system of FIG. 1 is described in greater detail below with reference to FIG. 6.

In this embodiment of the present invention, all of the elements and modules of the system of FIG. 1 are located on one computer system. In another embodiment of the present invention, the elements and modules of the system of FIG. 1 are distributed over a distributed computer system. This embodiment allows for the use of the present invention in a distributed computing environment. This also allows for the remote storage and/or backup of the information in database 108. This is beneficial as it allows for more than one copy of the database 108 to exist on a network, which reduces the possibility of information loss in the event of a system crash or other disaster.

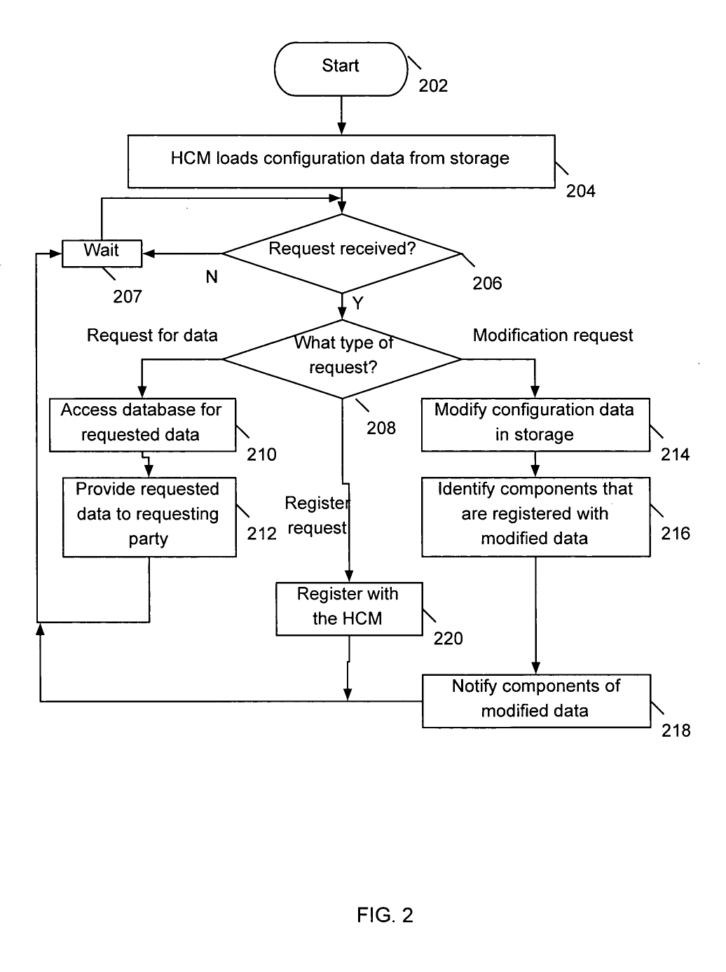

FIG. 2 is a flowchart depicting the overall operation and control flow of the hierarchical configuration manager of one embodiment of the present invention. The operation and control flow of FIG. 2 depicts the overall processes of the present invention. The operation and control flow of FIG. 2 begins with step 202 and proceeds directly to step 204.

In step 204, the HCM 102 is initialized, which includes the reading of configuration data from the database 108. In step 206, it is determined whether a request is received. If the result of the determination of step 206 is affirmative, then control flows to step 208. Otherwise, control flows to step 207. In step 207, HCM 102 waits for a predetermined period of time, after which control flows back to step 206. In step 208, it is determined which type of request was received in step 206. If the request is a request for configuration data, then control flows to step 210. If the request is a request to modify configuration data, then control flows to step 214. If the request is a registration request, then control flows to step 220.

In step 210, the HCM 102 accesses the database 108 for the requested configuration data. In step 212, the requested configuration data is provided to the requesting party by the HCM 102. In one example of the execution of steps 204-212, an email application component sends a request to the HCM 102 for a reply-to email address. The HCM 102 accesses the database 108, retrieves the requested configuration value and provides to the email application component. After step 212, control flows back to step 207, where the process is repeated.

In step 214, the HCM 102 receives a request to modify configuration data and accesses the database 108 to modify the configuration data. In step 216, the HCM 102 identifies those application components that have registered to be notified when this configuration value is modified. In step 218, the HCM 102 notifies those application components that have registered to be notified when the modified configuration value is modified. In one example of the execution of steps 204-218, a GUI being utilized by a user sends a request to the HCM 102 to modify a reply-to email address. The HCM 102 accesses the database 108, modifies the configuration value and notifies those application components that have registered to be notified when that configuration value is modified. After step 218, control flows back to step 207, where the process is repeated.

In step 220, the HCM 102 receives a registration request. Consequently, the HCM 102 registers the application component as an interested party to receive notification whenever there is any change in one or more specified configuration values. For example, the application component can register interest in a particular node of the hierarchical tree (i.e., a single configuration value) or an entire sub-tree of configuration values. After step 220, control flows back to step 207, where the process is repeated.

### 6. The Dynamic Configuration Data Update Process

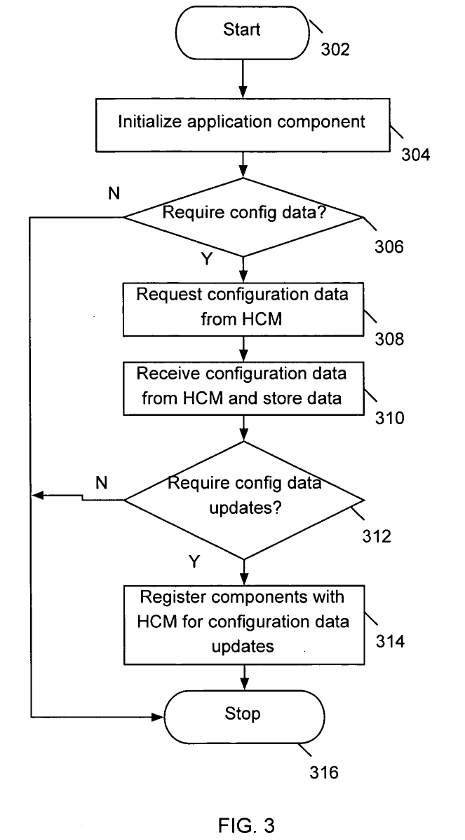

FIG. 3 is a flowchart depicting the operation and control flow of the application component start-up process of one embodiment of the present invention. The operation and control flow of FIG. 3 begins with step 302 and proceeds directly to step 304. In step 304, the application component, such as application component 104, is initialized. In step 306, it is determined whether the application component requires configuration data from the HCM 102. If the result of the determination of step 306 is affirmative, control flows to step 308. Otherwise, control flows to step 316.

In step 308, the application component requests certain configuration data from the HCM 102. In step 310, the application component receives the requested data from the HCM 102 and stores the data. More detail on the data request and response is described above with respect to steps 206 to 212 of FIG. 2. In step 312, it is determined whether the application component requires updates on the configuration data from the HCM 102. If the result of the determination of step 312 is affirmative, control flows to step 314. Otherwise, control flows to step 316.

In step 314, the HCM 102 registers the application component as an interested party to receive notification whenever there is any change in one or more specified configuration values, as described above with reference to step 220 of FIG. 2. In general, more detail on data modification requests and corresponding responses is provided above with respect to steps 206 to 218 of FIG. 2. In step 316, the control flow of FIG. 3 stops.

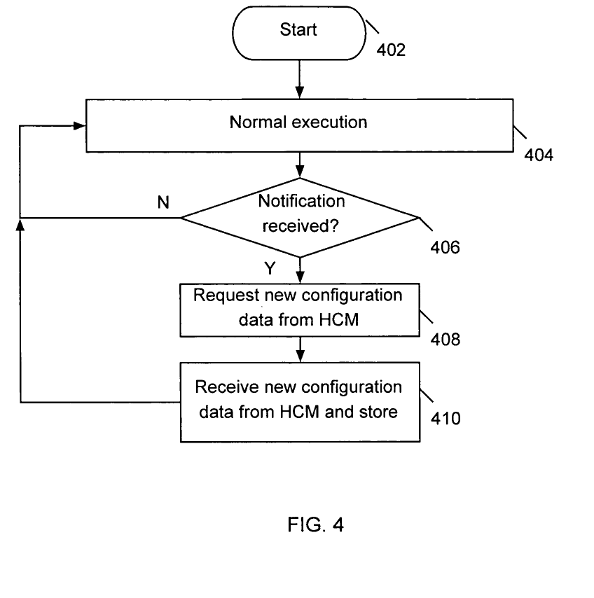

FIG. 4 is a flowchart depicting the operation and control flow of the application component execution process of one embodiment of the present invention. The operation and control flow of FIG. 4 begins with step 402 and proceeds directly to step 404. In step 404, the application component, such as application component 104, executes normally. In step 406, it is determined whether the application component has received a configuration data modification notice from the HCM 102. If the result of the determination of step 406 is affirmative, control flows to step 408. Otherwise, control flows back to step 404.

In step 408, the application component requests certain configuration data (the configuration data referenced in the notification of step 406) from the HCM 102. In step 410, the application component receives the requested configuration data from the HCM 102 and stores the data. More detail on the data request and response is provided above with respect to steps 206 to 212 of FIG. 2. In one alternative embodiment of the present invention, the configuration data referenced in the notification of step 406 is automatically transmitted to the application component in step 406, eliminating the need for step 408. Subsequent to step 410, control flows back to step 404.

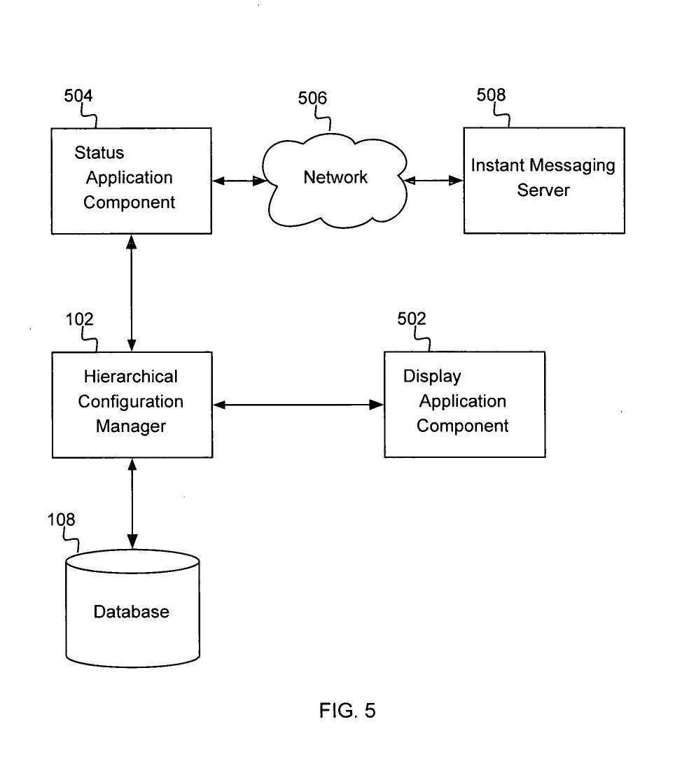

FIG. 5 is a block diagram of an exemplary system architecture for an instant messaging application according to one embodiment of the present invention. FIG. 5 shows the HCM 102 and the database 108. FIG. 5 also shows an instant messaging server 508 for handling instant messaging functions over a network. The instant messaging server 508 is connected to a network 506.

In one embodiment of the present invention, the network 506 is a circuit switched network, such as the Public Service Telephone Network (PSTN). In another embodiment, the network is a packet switched network. The packet switched network is a wide area network (WAN), such as the global Internet, a private WAN, a local area network (LAN), a telecommunications network or any combination of the above-mentioned networks. In yet another embodiment, the network is a wired network, a wireless network, a broadcast network or a point-to-point network.

FIG. 5 also shows a display application component 502, or GUI, that handles graphical display of certain information, such as a buddy list, perhaps using colors and icons to indicate buddy status, and provides a means for the user to send and receive messages to buddies.

FIG. 5 also shows a status application component 504 that communicates with the instant messaging server 508 and receives notifications for any status changes. When a status change occurs, the status application component 504 sends a message to the HCM 102. The HCM 102 determines which buddy's status has changed, and updates its internal data structures in the database 108 accordingly. Furthermore, because the display application component 502 has registered its interest for changes in buddy status, the HCM 102 sends the updated configuration data to the display application component 502, at which point the display application 502 component can update its display.

### 7. Tree and Queries in an Exemplary XML Implementation

In this exemplary implementation, an XML tree is used to store the configuration data. The XML tree includes user-definable types for defining structures. The configuration manager provides a system and syntax to allow application components to define queries that refer to the structure of the XML tree and the stored configuration values. The configuration manager parses the XML tree and notifies the application component when values matching its query are added or changed. Some exemplary scenarios that show the power and flexibility of this configuration manager will now be described with reference to the following portion of an XML schema and portion of a hierarchical XML tree.

```
<xsd:element name=“user” type=“client1:user” />
  <xsd:complexType name=“user”>
    <xsd:sequence>
      <xsd:element name=“name” type=“other:name” />
      <xsd:element name=“id” type=“other:email-address” />
      <xsd:element name=“nickname” type=“xsd:string” />
      <xsd:element name=“homepage” type=“xsd:anyURI” />
      ...
    </xsd:sequence>
  </xsd:complexType>
<instant-messaging-config>
  <login-info>
    ...
  </login-info>
  ...
  <users>
  <user xsi:type=“client1:user”>
      <name title=“Dr.”>Alice B. Smith</name>
      <id>absmith@ibm.com</id>
      <nickname>Alice</nickname>
      <homepage>http://ibm.com/smith/alice.html</homepage>
      <.../>
    </user>
    <user> ... </user>
    <user> ... </user>
  </users>
  ...
</instant-messaging-config>
```

The first schema fragment above defines the XML data structure for a valid “user” in the buddy list of an instant messaging client1 application. This user is defined as a new type on the second line above. In the first scenario, the application component that implements support for instant messaging client1 registers its interest in configuration values by submitting a query to the configuration manager. The configuration manager then notifies the application component upon any new element matching the query. For example, if the configuration manager is built around an XML parser that uses the standard xpath syntax for querying an XML document, then the query “instant-messaging-config/users/user” requests that the application component be notified whenever a new user is added to the buddy list. The xpath parser would also be general enough to allow an application component to make more specific queries, such as whether any user added to the buddy list has an “ID” element containing “@company.com”. A description of xpath is available on the Internet at “www.w3.org/TR/xpath”, which is herein incorporated by reference.

The application component can submit a one-time query, or can set up a standing query so that the configuration manager notifies the application component whenever a change in configuration data matches that component's query. For example, this would allow an application component to be written to perform additional processing whenever a new user added to the buddy list has an “ID” element containing “@company.com”, such as filling in information in the user's profile from a corporate database. Further, the application component could request notification for any change in the configuration data of any user added to the buddy list having an “ID” element containing “@company.com”, so as to be alerted to office moves by the corporate database's configuration manager.

The portion of the XML tree shown below is used in the second scenario.

```
<user xsi:type=“client1:user”>
  <name>John Q. Smith</name>
  <id>jqsmith@ibm.com</id>
  <nickname>Johnny</nickname>
  <homepage>http://ibm.com/John-Q-Smith.html</homepage>
  <... />
</user>
```

In this second scenario, a second application component that integrates with a web browser's “favorites” list submits a query so as to register with the configuration manager for notification upon any new element matching the standard W3C XML schema type “xsd:URI”. (A description of the standard W3C XML schema is available on the Internet at “www.w3.org/TR/xmlschema-1” and “www.w3.org/TR/xmlschema-2”, which are herein incorporated by reference.)

If “John Smith” is then added to the buddy list of application client 1 through the schema fragment above, the configuration manager notifies the second application component that it found a URI schema type in this new configuration data. This would allow the second application component to pop up a window to ask the user whether this URI should be added to the favorites list. Thus, anytime an element of the specified type is added anywhere in the XML tree, the application component is notified, even if the application component knows nothing about the structure of that portion of the XML tree.

The following schema fragment is used in the third scenario.

```
<xsd:element name=“user” type=“client2:user” />
  <xsd:complexType name=“user”>
    <xsd:sequence>
      <xsd:element name=“name” type=“other:name” />
      <xsd:element name=“id” type=“other:email-address” />
      <xsd:element name=“picture” type=“xsd:URI” />
      <xsd:element name=“public-key” type=“xsd:hexBinary” />
    </xsd:sequence>
  </xsd:complexType>
<xsd:complexType name=“required-user-info”>
  <xsd:sequence>
    <xsd:element name=“name” type=“other:name” />
    <xsd:element name=“id” type=“other:email-address” />
    <xsd:any namespace=‘##other’ processContents=‘skip’
          minOccurs=“0” maxOccurs=“unbounded” />
  </xsd:sequence>
</xsd:complexType>
```

In this third scenario, a third application component supports instant messaging client2. This third application component desires to be notified of all users that are added to the XML tree by any application regardless of the schema type that was used to validate that user's data when it was added to the XML tree, so as to allow the third application component to use just the new user's name and id values to query the client2 application's user database. If a match is found in this database, then the third application component can pop up a window to ask whether this new user should also be added to the client2 application. For this purpose, the XML schema fragment above shows the schema type definition for the “user” type used by the client2 application, as well as a schema type definition for the minimum amount of information that is needed in order to identify a user. The third application component registers with the configuration manager to be notified whenever a new element is added using xpath query “instant-messaging-config/users/user”. This query validates against the type client2:required-user-info. So, when John Smith is added, the configuration manager tries to validate the data for the new user against the type client2:required-user-info. In other words, the configuration manager ignores what the type actually is, and tries parsing it as a different type. If it succeeds, then the third application component is notified.

Accordingly, embodiments of the present invention provide for storage of configuration values of various types in a structured hierarchy. Application components create complex queries that depend on location in the hierarchy, data types, and/or actual stored values. The queries may also match subtrees of the hierarchy. The configuration manager notifies components when values matching a query are added or changed. For example, XML can be used to provide a structure for storing such a hierarchy. The XML schema describes this structure and the types it stores, application components describe queries (e.g., using xpath) that trigger notification.

### 8. Exemplary Implementations

The present invention can be realized in hardware, software, or a combination of hardware and software in a computer. A computer system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer program product on a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

FIG. 6 is a block diagram of a computer system useful for implementing an embodiment of the present invention. The computer system of FIG. 6 includes one or more processors, such as processor 604. The processor 604 is connected to a communication infrastructure 602 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 608 that forwards graphics, text, and other data from the communication infrastructure 602 (or from a frame buffer not shown) for display on the display unit 610. The computer system also includes a main memory 606, preferably random access memory (RAM), and may also include a secondary memory 612. The secondary memory 612 may include, for example, a hard disk drive 614 and/or a removable storage drive 616, representing a floppy disk drive, a magnetic tape drive, an optical disk drive, etc. The removable storage drive 616 reads from and/or writes to a removable storage unit 618 in a manner well known to those having ordinary skill in the art. Removable storage unit 618, represents, for example, a floppy disk, magnetic tape, optical disk, etc. which is read by and written to by removable storage drive 616. As will be appreciated, the removable storage unit 618 includes a computer usable storage medium having stored therein computer software and/or data.

In alternative embodiments, the secondary memory 612 may include other similar means for allowing computer programs or other instructions to be loaded into the computer system. Such means may include, for example, a removable storage unit 622 and an interface 620. Examples of such may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to the computer system.

The computer system may also include a communications interface 624. Communications interface 624 allows software and data to be transferred between the computer system and external devices. Examples of communications interface 624 may include a modem, a network interface (such as an Ethernet card), a communications port, a PCMCIA slot and card, etc. Software and data transferred via communications interface 624 are in the form of signals which may be, for example, electronic, electromagnetic, optical, or other signals capable of being received by communications interface 624. These signals are provided to communications interface 624 via a communications path (i.e., channel) 626. This channel 626 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory and secondary memory, a removable disk for use in a removable storage drive, a hard disk installed in hard disk drive, and signals. These computer program products are means for providing software to the computer system. The computer system can read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network.

Computer programs (also called computer control logic) are stored in main memory 606 and/or secondary memory 612. Computer programs may also be received via communications interface 624. Such computer programs, when executed, enable the computer system to perform the features of the present invention as discussed herein. In particular, the computer programs, when executed, enable the processor 604 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A method for managing configuration data, the method comprising the steps of:
storing a plurality of configuration values in a hierarchical tree having a plurality of nodes, a defined structure, and defined data types for the stored configuration values, wherein each node is associated with at least one configuration value;
registering at least one application component with at least one of the nodes of the tree, based on at least one query received from the at least one application component; and
notifying the at least one application component when a configuration value associated with the at least one node is modified, based on an addition or change in at least one configuration value that matches the at least one query.

2. The method of claim 1, wherein the at least one query depends on at least one of a location of a configuration value in the tree and a data type of a configuration value.

3. The method of claim 1, wherein the hierarchical tree is an Extensible Markup Language (XML) tree, and an XML schema describes the structure of the XML tree and the data types that are stored.

4. The method of claim 1, wherein the at least one application component comprises a plurality of components of an email application.

5. The method of claim 1, wherein a node further includes a reference to at least one node.

6. The method of claim 1, wherein the notifying step comprises:
modifying at least one configuration value;
storing in the hierarchical tree the configuration value that was modified; and
notifying the at least one application component that the configuration value was modified.

7. The method of claim 6, further comprising the step of supplying the configuration value that was modified to the at least one application component.

8. The method of claim 1, further comprising the step of supplying at least one of the configuration values stored in the hierarchical tree to the at least one application component.

9. A computer program product for managing configuration data, the computer program product comprising:
a storage medium readable by a processing circuit and storing instructions for execution by the processing circuit for performing a method comprising the steps of:
storing a plurality of configuration values in a hierarchical tree having a plurality of nodes, a defined structure, and defined data types for the stored configuration values, wherein each node is associated with at least one configuration value;
registering at least one application component with at least one of the nodes of the tree, based on at least one query received from the at least one application component; and
notifying the at least one application component when a configuration value associated with the at least one of the plurality of nodes is modified, based on an addition or change in at least one configuration value that matches the at least one query.

10. The computer program product of claim 9, wherein the at least one query depends on at least one of a location of a configuration value in the tree and a data type of a configuration value.

11. The computer program product of claim 9, wherein the hierarchical tree is an Extensible Markup Language (XML) tree, and an XML schema describes the structure of the XML tree and the data types that are stored.

12. The computer program product of claim 9, wherein the at least one application component comprises a plurality of components of an email application.

13. The computer program product of claim 9, wherein a node further includes a reference to at least one node.

14. The computer program product of claim 9, wherein the notifying step comprises:
modifying at least one configuration value;
storing in the hierarchical tree the configuration value that was modified; and
notifying the at least one application component that the configuration value was modified.

15. The computer program product of claim 14, wherein the method further comprises the step of supplying the configuration value that was modified to the at least one application component.

16. The computer program product of claim 9, wherein the method further comprises the step of supplying at least one of the configuration values stored in the hierarchical tree to the at least one application component.

17. A computer system for managing configuration data, the computer system comprising:
an organization module organizing a plurality of configuration values into a hierarchical tree having a plurality of nodes, a defined structure, and defined data types for the stored configuration values, wherein each node is associated with at least one configuration value;
storage storing the plurality of configuration values in the hierarchical tree;
a registration module registering at least one application component with at least one of the nodes of the tree, based on at least one query received from the at least one application component; and
a notification module notifying the at least one application component when a configuration value associated with the at least one node is modified, based on an addition or change in at least one configuration value that matches the at least one query.

18. The computer system of claim 17, wherein the at least one query depends on at least one of a location of a configuration value in the tree and a data type of a configuration value.

19. The computer system of claim 17, wherein the hierarchical tree is an Extensible Markup Language (XML) tree, and an XML schema describes the structure of the XML tree and the data types that are stored.

20. The computer system of claim 17, wherein the at least one application component comprises a plurality of components of an email application.
